(19) United States
(12) Patent Application Publication
(10) Pub. No.: US 2003/0042459 A1
(43) Pub. Date: Mar. 6, 2003

(54) Unitary diaphragm and seat assembly

(76) Inventor: Roger J. Gregoire, Bulverde, TX (US)

Correspondence Address: HOWREY SIMON ARNOLD & WHITE LLP, 1299 PENNSYLVANIA AVE., NW, BOX 34, WASHINGTON, DC, 20004, US

(21) Appl. No.: 10/064,928

(22) Filed: Aug. 29, 2002

Related U.S. Application Data
(60) Provisional application No. 60/315,562, filed on Aug. 29, 2001.

(51) Int. Cl. F16K 1/00; F16K 15/00

(52) U.S. Cl. 251/331

(57) ABSTRACT

A unitary diaphragm and seat assembly for making the removal and replacement of diaphragms and seats practical, simple, and easy is taught. The inventive device includes a diaphragm cap, one or more diaphragms, and a diaphragm plate all respectively stacked and welded together in concentric alignment. A valve seat is attached to the lower face of the diaphragm plate. This assembly is concentrically retained within the valve body. The valve actuator installs over the top of the assembly and mechanically attaches onto the valve body. The diaphragm cap is a tubular shaped metal structure. The diaphragm is a circular thin metal disc preferably dome shaped. The diaphragm plate is a disc shaped metal structure having an upper and lower face. The valve seat is a tubular plastic structure. The valve body is a metal structure containing fluid ports and attachment means to a valve actuator. The valve actuator can be any assembled structure that can selectively apply or remove a force upon the diaphragms and is mechanically attached to the valve body.

### CROSS REFERENCE TO RELATED APPLICATIONS

The present application claims priority to U.S. Provisional Application No. 60/315,562, filed Aug. 29, 2001.

### BACKGROUND OF INVENTION

1. Technical Field

The present invention generally relates to metal diaphragm valves. More specifically, it relates to a unitary diaphragm and seat assembly whereby the removal and replacement of diaphragms and seats are made practical, simple, and easy.

2. Background Information

Metal diaphragm valves have been in use for years. Typically, metal diaphragm valves include a body section, an actuator section, and one or more metal diaphragms. The actuator selectively applies a force or removes it from the diaphragm(s), which in turn deflects into or away from a valve seat contained within the body, thereby respectively shutting off or allowing fluid flow through the body section. The actuator mechanically attaches to the body, clamping on the outer periphery of the diaphragms and forming a fluid tight seal between the actuator and the body, thereby preventing leakage of the controlled fluid into the atmosphere or into the actuator section. Typical valves of this type are found in U.S. Pat. Nos. 5,131,627 and 5,326,078.

Conventional metal diaphragm valves tend to be difficult, if not impossible, to remove and replace the valve seat that is crimped into the valve body section. When a valve seat fails, the entire body section typically is discarded and replaced with a new body section containing the new valve seat. This problem of replacement is even more complicated in an all-welded gas/fluid system, where multiple valve bodies are welded together, or where a valve body is welded to other components. Such valve bodies, when they fail, require a lengthy system downtime to remove and replace the body that contains the failed valve seat.

In high purity and hazardous gas systems such as those typically found within the semiconductor industry, it is desirable to eliminate or minimize the number of mechanical fluid connections. Therefore, the valve bodies and components are typically welded together so as to make the entire gas system smaller, safer (due to the reduction of mechanical seals-to-atmosphere), and cleaner (due to the reduction of wetted surface area). Alternatively, machined manifolds are available that integrally encompass multiple valve body sections with interconnecting fluid passageways. Although the all-welded system or the integral machined manifold is smaller, safer, and cleaner, they still present the problem of or inability to easily remove and replace a failed valve seat. Should a valve seat fail, the entire machined manifold or the all-welded manifold of valve bodies and components needs to be replaced or repaired with much difficulty. This is very impractical in a manufacturing environment, as it requires much downtime and is very costly.

An attempt to alleviate this problem is found in the diaphragm valve of U.S. Pat. No. 5,485,984. Although this invention does allow the valve seat to be easily removed and replaced, it does so by creating an additional mechanical atmospheric seal for each valve body section. The additional mechanical atmospheric seal or seal-to-atmosphere is located at the bottom of the removable metallic elastic seating ring. The first mechanical seal-to-atmosphere is located at the top of the seating ring where the diaphragm is clamped. Due to the toxic and hazardous properties of some of the gases and fluids that are controlled by these metal diaphragm valves, it is very critical that the potential for leakage, especially leakage to atmosphere where people are present, is minimized.

Another problem with conventional metal diaphragm valves is that when the valve seat or valve body section is replaced, the diaphragm(s) must also be replaced. When installed, the thin diaphragm is clamped and crushed on its outer periphery, plastically deforming and creating a seal by conforming to the unique micro peaks-and-valleys pattern of the mating surface. Therefore, it is considered a one-time seal, requiring replacement when the valve seat or valve body is replaced.

Further, in conventional metal diaphragm valves the diaphragm itself can be difficult to remove and replace, particularly in those instances where it is necessary that the valve be repaired without removing it from its gas system. In valves such as that taught in U.S. Pat. No. 5,326,078, where the diaphragm sits within a cavity within the body section, it is very difficult to remove the diaphragm since the outside diameter of the diaphragm is only slightly smaller than the cavity diameter. In valves where there is no cavity for the diaphragm to sit in, such as that taught in U.S. Pat. No. 5,131,627, it is difficult to install the diaphragm so that it is concentrically aligned to other diaphragms and to the valve seat unless the valve body section is mounted in a horizontal position.

A diaphragm can shift off-center during its replacement process. Such a non-concentric diaphragm can cause an atmospheric leak at the actuator-to-body connection, as well as create higher diaphragm stresses. This results in a reduction of diaphragm cycle life and requires increased actuator forces to create a positive shut-off on the valve seat.

While these devices may be suitable for the particular purpose to which they address, they still do not provide a solution for making the removal and replacement of diaphragms and seats practical, simple, and easy. Accordingly, there is a need for a unitary diaphragm and seat assembly that makes the removal and replacement of diaphragms and seats practical, simple, and easy.

### SUMMARY OF INVENTION

In view of the foregoing disadvantages inherent in known types of metal diaphragm valves, the present invention provides a new unitary diaphragm and seat assembly construction wherein the same can be utilized for making the removal and replacement of diaphragms and seats practical, simple, and easy.

Accordingly, a diaphragm and seat assembly disposable within a diaphragm valve is provided, the assembly having one or more diaphragms, a diaphragm cap for supporting one side of the one or more diaphragms, a diaphragm plate for supporting an opposite side of the one or more diaphragms, and a valve seat for engaging with the one or more diaphragms, thereby blocking flow through the diaphragm valve when engaged with the one or more diaphragms and allowing flow through the diaphragm valve when disengaged with the one or more diaphragms. The diaphragm cap and the diaphragm plate are fixedly joined together with the one or more diaphragms disposed there between, providing a singular assembly for disposal within the diaphragm valve.

The present invention further provides a diaphragm valve having a valve actuator for operating at least one diaphragm; a valve body having an inlet port and passage and an outlet port and passage and an internal chamber for providing fluid communication between the inlet port and passage and the outlet port and passage; and a singular diaphragm assembly having at least one diaphragm disposed therein and a valve seat for engaging with the at least one diaphragm.

As such, the present invention provides a new unitary diaphragm and seat assembly that has many of the advantages of the metal diaphragm valves mentioned above while providing many novel features wherein the removal and replacement of diaphragms and seats is practical, simple, and easy.

Further, the present invention provides a unitary diaphragm and seat assembly that allows for the easy removal and replacement of the valve seat. The present inventions also provides a unitary diaphragm and seat assembly that allows for the easy removal and replacement of the valve seat without including additional mechanical seals-to-atmosphere.

The present invention further provides a unitary diaphragm and seat assembly that allows for the easy removal and replacement of the valve seat without replacing the diaphragms. The present invention also provides a unitary diaphragm and seat assembly that allows for the easy removal and replacement of the diaphragms.

The present invention further provides a unitary diaphragm and seat assembly that maintains the diaphragms and the valve seat in concentric alignment.

The present invention provides a unitary diaphragm and seat assembly that has a redundant mechanical body seal-to-atmosphere.

To accomplish this, the present invention generally includes a diaphragm cap, one or more diaphragms, and a diaphragm plate stacked and welded together in concentric alignment. A valve seat is attached to the lower face of the diaphragm plate. This assembly is concentrically retained within the valve body. The valve actuator installs over the top of the assembly and mechanically attaches onto the valve body. The diaphragm cap is a tubular shaped metal structure. The diaphragm is a circular thin metal disc, preferably dome shaped. The diaphragm plate is a disc shaped metal structure having an upper and lower face. The valve seat is a tubular plastic structure. The valve body is a metal structure containing fluid ports and attachment means to a valve actuator. The valve actuator can be any assembled structure that can selectively apply or remove a force upon the diaphragms and is mechanically attached to the valve body.

There has thus been outlined, rather broadly, the more important features of the invention in order that the detailed description thereof may be better understood, and in order that the present contribution to the art may be better appreciated. There are additional features of the invention that will be described hereinafter.

In this respect, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

Other objects and advantages of the present invention will become obvious to the reader, and it is intended that these objects and advantages be within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an exploded view of a diaphragm valve incorporating the present invention.

FIG. 2 is a cross sectional partial view of a diaphragm valve, the valve being shown in the closed position.

FIG. 3 is a cross sectional partial view of a diaphragm valve, the valve being shown in the open position.

FIG. 4 is a cross sectional view of the diaphragm and seat assembly.

FIG. 5 is a cross sectional exploded view of the diaphragm and seat assembly.

FIG. 6 is a cross sectional view showing the redundant seal-to-atmosphere.

### DETAILED DESCRIPTION

Turning now to the drawings, in which similar reference characters denote similar elements throughout the several views, there is illustrated a unitary diaphragm and seat assembly 10 that includes a diaphragm cap 20, one or more diaphragms 30, and a diaphragm plate 40, all respectively stacked and welded together in concentric alignment. A valve seat 50 is attached to the lower face of the diaphragm plate 40. This assembly 10 is concentrically retained within a valve body 70. A valve actuator 60 installs over or is fitted over the top of the assembly 10, mechanically attaching onto the valve body 70.

As illustrated, the diaphragm cap 20 is tubular in shape. The diaphragm cap 20 can be manufactured from a variety of materials, but preferably is a metal structure. The diaphragm 30 is a circular thin metal disc, conforming to the shape of the diaphragm cap 20. The diaphragm 30 is preferably dome shaped, although it can also be flat. The diaphragm plate 40 is a disc shaped metal structure having an upper and lower face 41, 42. The valve seat 50 is tubular in shaped so as to conform to the shape of the diaphragm plate 40. Like the diaphragm cap 20, diaphragm 30 and diaphragm plate 40, it can be made from a variety of materials; however, the valve seat 50 is preferably a polymer or plastic composite. The valve body 70 is a metal structure containing fluid ports and is able to attach to a valve actuator 60. The valve actuator 60 refers to any assembled structure that can selectively apply or remove a force upon the diaphragms and can be mechanically attached to the valve body 70.

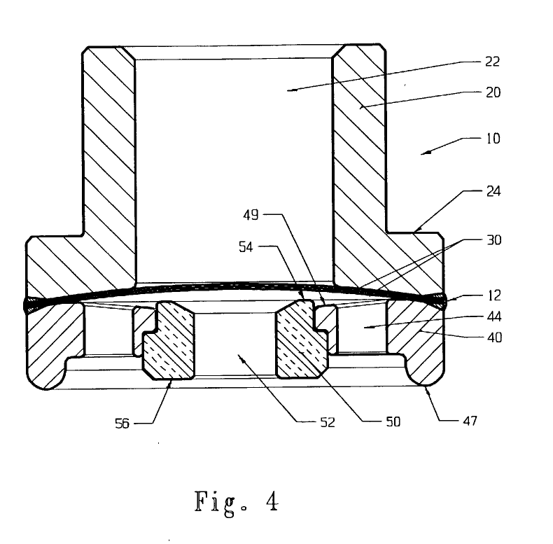

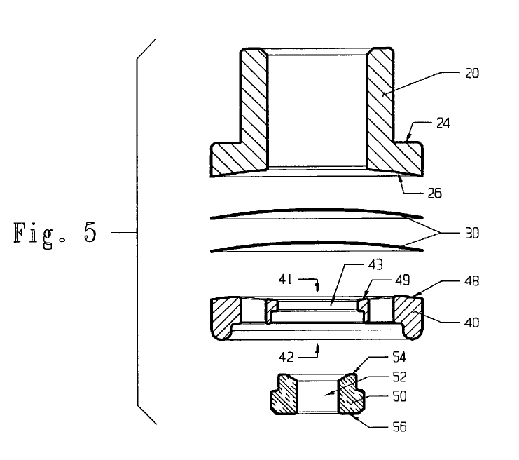

Referring to FIGS. 4 and 5, the diaphragm cap 20 has a central through-hole 22. At the lower end of diaphragm cap 20 is a diaphragm cap surface 26 that conforms to or is approximately matching in size to that of the diaphragm 30. As illustrated, the cap surface 26 extends outwardly from the diaphragm cap 20 forming a cap shoulder 24. In another embodiment, the surface 26 can taper outwardly from the wall of the diaphragm 20 substantially or approximately the radius of diaphragm 30. The radial length of surface 26 extending inward from the outer diameter can be as small as needed to accommodate penetration of a weld 12, e.g., as little as 0.020 of an inch. Extending the radial length of surface 26 provides additional support for diaphragm 30.

The diaphragm plate 40, like the diaphragm cap 20, has a central through-hole 43. Other through-holes 44 can be positioned radially out from the central through-hole 43. These through-holes 44 may be one or more in quantity. The upper face 41 of the diaphragm plate 40 has an outer surface 48 that conforms approximately to that of diaphragm 30. Leading from the upper face outer surface 48 and tapering radially inwardly is an upper face inner surface 49. Extending downwardly from the outer periphery of the diaphragm plate lower face 42 is toroid 47. The outer surface 48 can be tapered instead of extending outwardly radially so as to approximate the radius of diaphragm 30. The radial length of the outer surface 48 extending inward from its outer diameter need only be small enough to accommodate penetration of weld 12, e.g. , as little as 0.020 inch. The inner surface 49 can also be a recessed section, such as a counterbore, so as to allow diaphragm deflection clearance.

The valve seat 50 has a generally annular configuration, with a central through-hole 52, an upper sealing edge 54 and a lower sealing edge 56. The sealing edges 54, 56 can also be radial or tapered edges. The valve seat 50 is fittingly engageable with the diaphragm plate 40. The valve seat 50 can be constructed from any material that has good strength and a low permeability, and is preferably constructed of a plastic material having these characteristics.

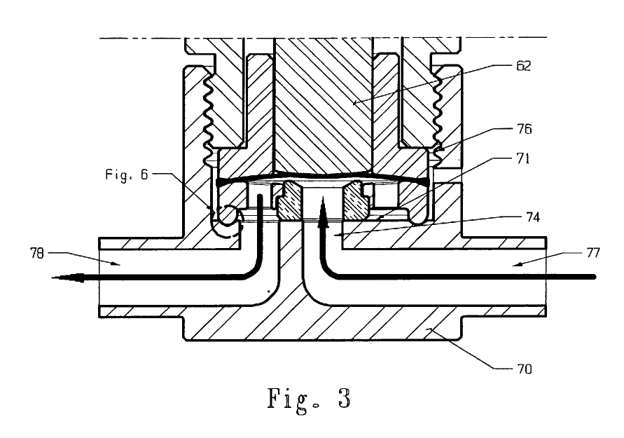

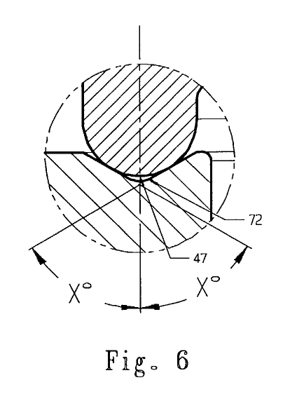

Referring to FIGS. 3 and 6, the valve body 70 contains attachment threads 76 and V-groove 72 where the toroid 47 meets the valve body 70, both being concentric with the center inlet port 74. The V-groove 72 angle as shown by the degrees X value in FIG. 6 can be any angle, but preferable is an angle greater than 45 degrees so as to prevent the toroid 47 of diaphragm plate 40 from sticking and wedging into groove when installed. Most preferably, the V-groove angle is about 60 degrees. The attachment threads 76 can be replaced with any appropriate connection technique.

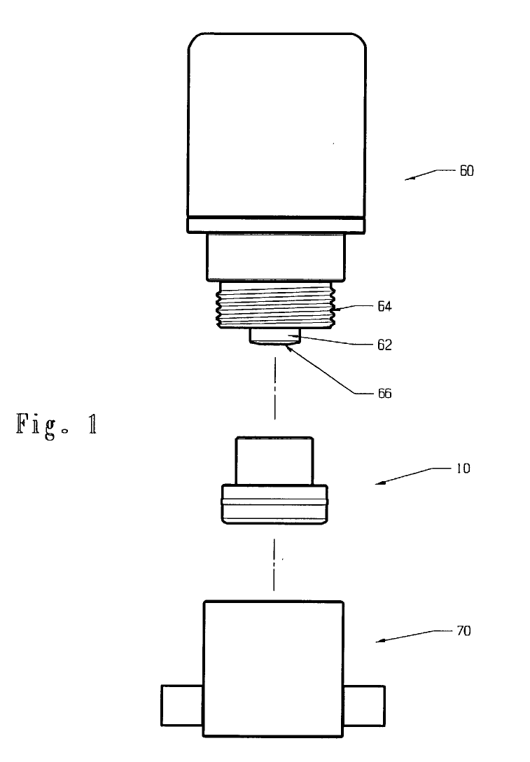

As illustrated in FIG. 1, the valve actuator 60 contains a valve stem 62 and attachment threads 64. The attachment threads 64 can be replaced with any appropriate connection technique. As illustrated, the valve body 70 is inwardly threaded. However, it should be understood that the valve body 70 can be outwardly threaded in another embodiment wherein the valve actuator 60 is inwardly threaded and the valve body is fitted or attached inside the actuator 60.

As shown in FIG. 1, the actuator section 60 is engageable with the valve body section 70, sandwiching the unitary diaphragm and seat assembly 10 in between. The diaphragm and seat assembly 10, which includes the diaphragm cap 20, one or more diaphragms 30, and diaphragm plate 40, is respectively stacked and sealingly connected together, preferably by welding, at the outer periphery junction. The valve seat 50 is friction-fit inserted at the lower end of the diaphragm plate 40 and retained in the through-hole 43. This assembly therefore retains each of these components in concentric alignment. The actuator stem 62 fits inside of the cap through-hole 22, and preferably is only slightly smaller in diameter than through-hole 22, thereby maintaining the actuator stem 62 in concentric alignment with diaphragm and seat assembly 10. The actuator mounting nut threads 64 are tightened and torqued so as to apply load onto both the cap shoulder 24 and the seal-to-atmosphere connection of the plate toroid 47 into the valve body V-groove 72.

Referring to FIG. 6, the center diameter of the V-groove 72 preferably matches that of the centerline diameter of the toroid 47. In the preferred embodiment, the toroid 47 contacts both sides of V-groove 72, effectively creating two series connected seals between the process fluid and atmosphere, or a redundant mechanical seal-to-atmosphere. The combination V-groove/toroid connection automatically self-centers, or concentrically aligns the diaphragm 30 and seat assembly 10 with the valve body 70. This connection has proven through testing to withstand multiple make and remakes. In an alternative embodiment, the toroid is integral with the valve body section and the mating V-groove is part of the diaphragm and seat assembly. A bushing may be used if desired between valve stem 62 and through-hole 22. There can be multiple means of attachment of valve seat 50 to diaphragm plate 40, such as snap-fit, friction-fit, press-fit, threaded, or any other suitable attachment means.

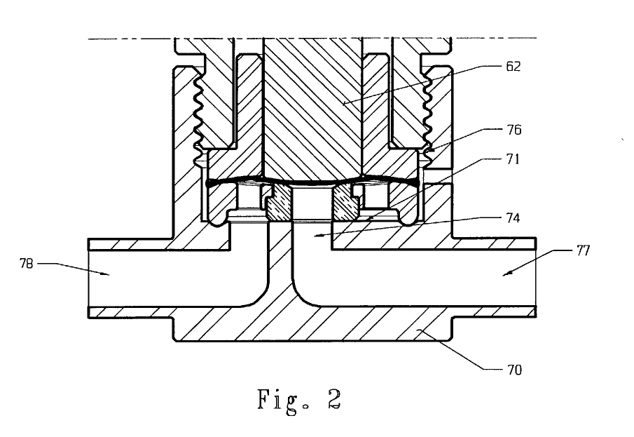

Referring to FIG. 2, the bottom surface 66 of the valve stem 62 applies a downward force onto the one or more diaphragms 30. This causes the diaphragms 30 to deflect downwardly onto the valve seat 50, thereby sandwiching the valve seat SO in between the diaphragms 30 and valve body face 71. This creates a seal on both edges 54 and 56 of the valve seat 50, sealingly shutting off fluid flow through the ports of the valve body 70.

Referring to FIG. 3, in the actuated open condition, the valve stem 62 moves upward, allowing the diaphragms 30 to flexibly return upwards. This allows fluid to flow through the inlet port 77, through valve seat through-hole 52, to the under side of the diaphragms 30, down through through-holes 44, and out through the outlet port(s) 78 of the valve body 70. To remove and replace the valve seat SO in the event of failure or seat leakage, the actuator 60 is removed, the unitary seat and diaphragm assembly 10 is removed, the seat 50 is pulled from the assembly 10 and a new seat 50 inserted, the assembly 10 with the new seat 50 is placed back into the valve body 70, and the actuator is reinstalled or reattached. In the event of a diaphragm failure, the steps are similar to those described above except that the assembly 10 would be replace as a unit, instead of just the valve seat 50. Alternatively, the assembly 10 can be replaced with the previous valve seat 50 reinstalled, although replacing the entire unit is preferred.

It should be recognized that the optimum dimensional relationships for the parts of the invention, including variations in size, materials, shape, form, function and manner of operation, assembly and use, are readily apparent and obvious to one skilled in the art. Further, all equivalent relationships to those illustrated in the drawings and described in the specification are encompassed by the present invention. Accordingly, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A diaphragm and seat assembly disposable within a diaphragm valve, the assembly comprising:
one or more diaphragms;
a diaphragm cap for supporting one side of the one or more diaphragms;
a diaphragm plate for supporting an opposite side of the one or more diaphragms; and
a valve seat for engaging with the one or more diaphragms, thereby blocking flow through the diaphragm valve when engaged with the one or more diaphragms and allowing flow through the diaphragm valve when disengaged with the one or more diaphragms;
wherein the diaphragm cap and the diaphragm plate are fixedly joined together with the one or more diaphragms disposed there between, providing a singular assembly for disposal within the diaphragm valve.

2. The diaphragm and seat assembly according to claim 1, further comprising a valve body for receiving the diaphragm and seat assembly.

3. The diaphragm and seat assembly according to claim 1, further comprising a valve actuator able to engage the assembly for operation of the one or more diaphragms.

4. The diaphragm and seat assembly according to claim 3, the diaphragm cap further comprising a central through-hole through which the actuator operates the one or more diaphragms.

5. The diaphragm and seat assembly according to claim 4, the actuator further comprising a valve stem for operating the one or more diaphragms.

6. The diaphragm and seat assembly according to claim 1, the diaphragm plate further comprising a central plate through-hole for receiving the valve seat.

7. The diaphragm and seat assembly according to claim 6 wherein the valve seat is removable from the diaphragm and seat assembly.

8. The diaphragm and seat assembly according to claim 2, further comprising a valve actuator engageable with the valve body for securing the diaphragm and seat assembly within the valve body.

9. The diaphragm and seat assembly according to claim 2, the diaphragm plate further comprising a toroid for engaging with the valve body thereby creating an atmospheric seal.

10. The diaphragm and seat assembly according to claim 9, the valve body further comprising a groove for receiving the toroid, whereby a series of one or more atmospheric seals are created.

11. A diaphragm valve comprising:
a valve actuator for operating at least one diaphragm;
a valve body having an inlet port and passage and an outlet port and passage and an internal chamber for providing fluid communication between the inlet port and passage and the outlet port and passage; and
a singular diaphragm assembly having at least one diaphragm disposed therein and a valve seat for engaging with the at least one diaphragm.

12. The diaphragm valve according to claim 11, the diaphragm assembly further comprising:
a diaphragm cap for supporting one side of the at least one diaphragm, and
a diaphragm plate for supporting an opposite side of the at least one diaphragm.

13. The diaphragm valve according to claim 11, the diaphragm assembly further comprising a toroid for engaging with the valve body, thereby creating an atmospheric seal.

14. The diaphragm valve according to claim 11, the valve body further comprising a groove for receiving the diaphragm assembly, thereby creating at least one atmospheric seal.

15. The diaphragm valve according to claim 11 wherein the valve seat is removable from the diaphragm assembly.

16. The diaphragm valve according to claim 11, wherein the internal chamber of the valve body is able to receive the diaphragm assembly.

17. The diaphragm valve according to claim 11 wherein the valve actuator is connectable with the valve body with the diaphragm assembly disposed there between, whereby the valve seat and the at least one diaphragm are concentrically aligned with the valve body.

18. The diaphragm valve according to claim 11, the valve body further comprising a toroid for placement of the diaphragm assembly thereon, thereby concentrically aligning the diaphragm assembly with the valve body.

19. The diaphragm valve according to claim 11, the diaphragm assembly further comprising a groove for engaging with the valve body, whereby the diaphragm assembly is concentrically aligned with the valve body.

20. The diaphragm valve according to claim 11, the diaphragm assembly further comprising a toroid for engaging with the valve body, and
the valve body further comprising a groove for receiving the toroid, whereby the diaphragm assembly is concentrically aligned with the valve body, and
wherein at least one atmospheric seal is created by the engagement of the toroid with the valve body.
